(19) United States
(12) Patent Application Publication
(10) Pub. No.: US 2009/0137134 A1
(43) Pub. Date: May 28, 2009

(54) BOARD TO BOARD CONNECTOR AND STACK STRUCTURE FOR STACKING PRINTED CIRCUIT BOARDS USING BOARD TO BOARD CONNECTOR

(75) Inventor: CHUN-PO CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/967,097

(22) Filed: Dec. 29, 2007

(30) Foreign Application Priority Data
Nov. 28, 2007 (CN) 200710202733.3

(51) Int. Cl. H01R 12/00

(52) U.S. Cl. 439/74

(57) ABSTRACT

A board to board connector (40) and a stack structure (100) for stacking at least two printed circuit boards are provided. The board to board connector includes a lower connecting portion (41), an upper connecting portion (42), and a plurality of conducting pins (43). The lower connecting portion, the upper connecting portion, and the conducting pins are integrally manufactured as a whole. The stack structure includes at least two present board to board connectors (70 and 80) corresponding with the at least two printed circuit boards (50 and 60). The at least two printed circuit boards each have a mounting hole (501 and 601) defined therethrough. The respective mounting hole is configured for mounting the respective board to board connector therein. The at least two printed circuit boards are electrically connected via physical connections of the at least two board to board connectors.

### BACKGROUND

1. Technical Field

The present invention relates to board to board connectors, particularly to a stack structure for stacking printed circuit boards using the board to board connectors.

2. Description of the Related Art

Usually, portable electronic device such as a mobile phone has two printed circuit boards, i.e., PCBs, stacked on one another. The two stacked PCBs, i.e., the first PCB and the second PCB, typically maintain an electric/electronic connection therebetween via the connection of the two board to board connectors. However, if a third PCB requires to further stack on the two stacked PCBs, two additional board to board connectors are required to achieve an electric/electronic connection between the third PCB and the two stacked PCBs.

In addition, the board to board connectors each are usually hot-pressure welded to an exterior surface of the respective PCB. The hot-pressure welding process is costly and, simultaneously the welded portion of the PCB becomes useless for mounting any electronic components thereon.

Therefore, a heretofore-unaddressed need exists in the art to address the aforementioned deficiencies and inadequacies.

### SUMMARY

In present aspect, a board to board connector is provided. The board to board connector includes a lower connecting portion, an upper connecting portion disposed on the lower connecting portion, and a plurality of conducting pins. The lower connecting portion, the upper connecting portion, and the plurality of conducting pins are integrally manufactured as a whole.

In another aspect, a stack structure for at least two printed circuit boards is provided. The stack structure includes at least two present board to board connectors corresponding with the at least two printed circuit boards. Each of the at least two printed circuit boards have a mounting hole defined therethrough. The respective mounting hole is configured for mounting the respective board to board connector therein. The at least two printed circuit boards are electrically connected via physical connections of the at least two board to board connectors.

These and other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present board to board connector and present stack structure for stacking printed circuit boards can be better understood with reference to the following drawings. These drawings are not necessarily drawn to scale, the emphasis instead being placed upon clearly illustrating the principles of the present board to board connector and present stack structure. Moreover, in the drawings like reference numerals designate corresponding parts throughout the several views. Wherever possible, the same reference numbers are used throughout the drawings to refer to the same or like elements of an embodiment.

FIG. 1 is an isometric view of a board to board connector in accordance with a present embodiment.

FIG. 2 is a sectional view of the board to board connector shown in FIG. 1, taken along line II-II.

FIG. 3 is another isometric view of the board to board connector shown in FIG. 1, showing another aspect thereof.

FIG. 4 is an assembled view of a stack structure for stacking two printed circuit boards using two board to board connectors shown in FIG. 1.

FIG. 5 is an exploded view of the assembled board to board connectors and two printed circuit boards.

FIG. 6 is a cut-away view of the assembled board to board connectors and two printed circuit boards shown in FIG. 5, taken along line VI-VI.

### DETAILED DESCRIPTION OF THE EMBODIMENTS

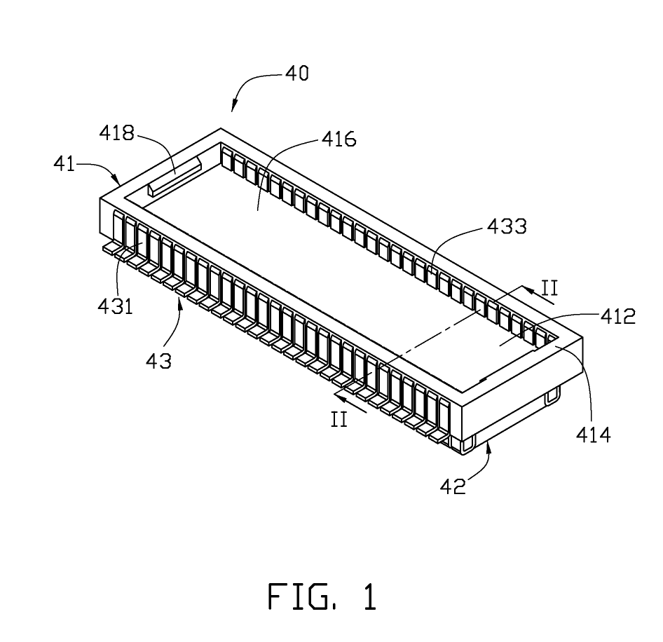

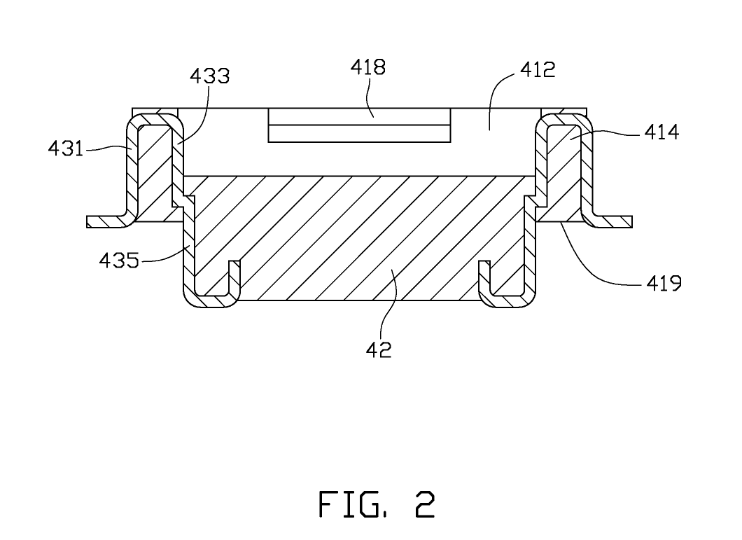

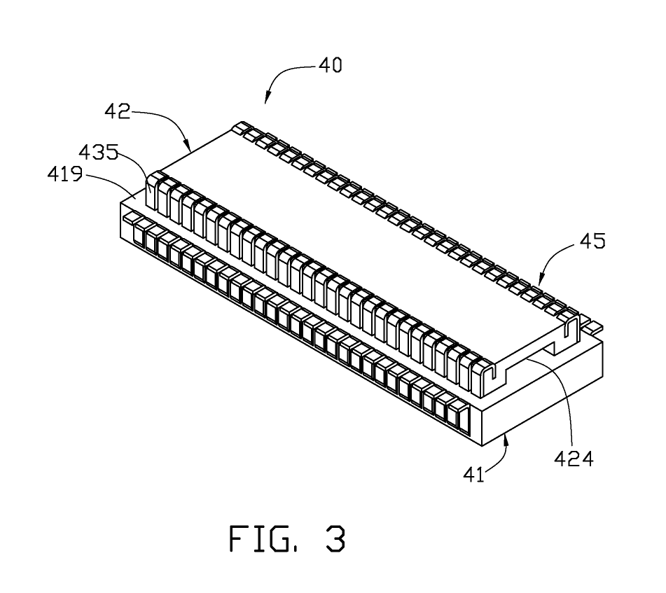

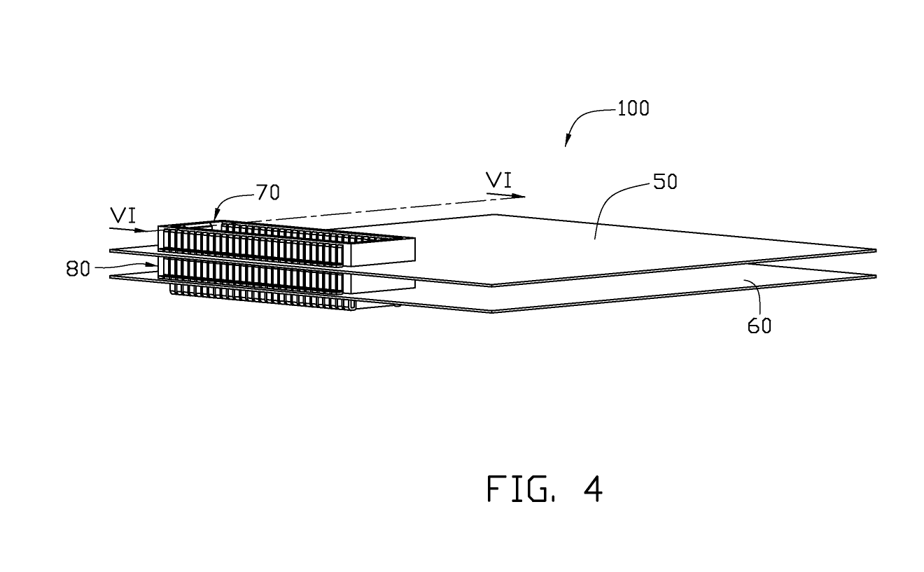

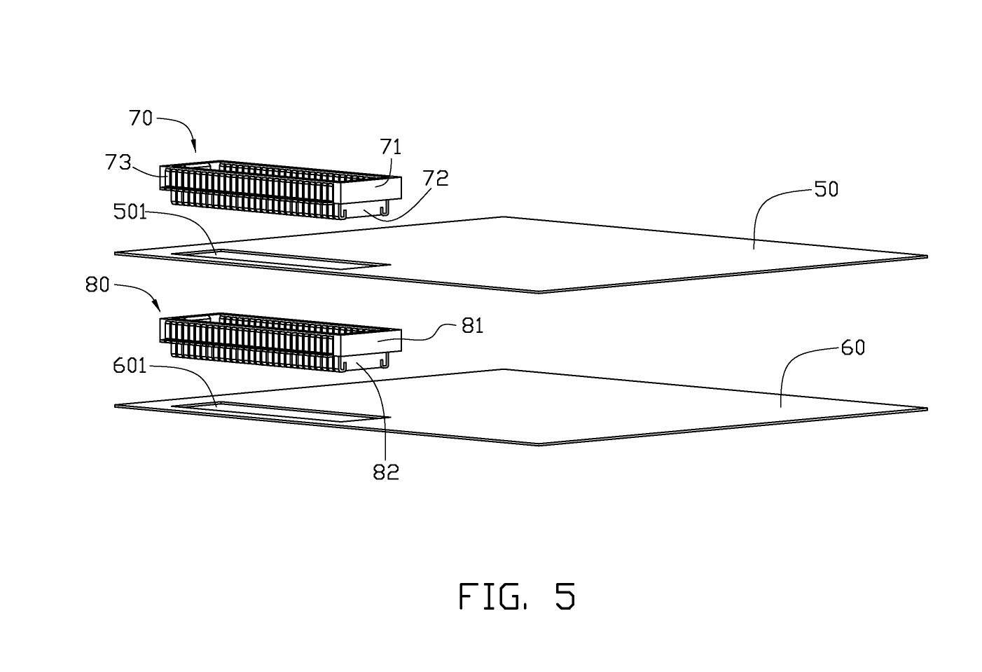

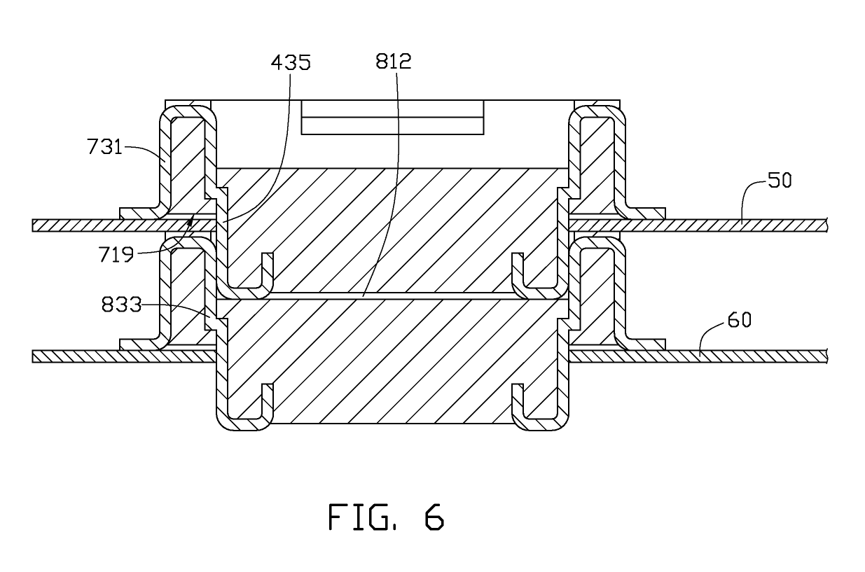

The present board to board connector for an electronic device (e.g., a mobile phone) is described here in conjunction with the accompanying drawings in FIGS. 1 through 3. Two present board to board connectors, which are configured (i.e., structured/arranged) for facilitating an electric/electronic connection of two stacked printed circuit boards (i.e., PCBs), are described here in conjunction with the accompanying drawings in FIGS. 4 through 6.

Referring to FIGS. 1 though 3, the board to board connector 40 includes a lower connecting portion 41, an upper connecting portion 42, and a plurality of conducting pins 43. The lower connecting portion 41, the upper connecting portion 42, and the plurality of conducting pins 43 are integrally manufactured as a whole.

The lower connecting portion 41 is generally rectangular, which is defined with a hollow receiving cavity 412. The receiving cavity 412 has substantially the same size and shape as that of the upper connecting portion 42. Advantageously, the receiving cavity 412 is generally rectangular. The receiving cavity 412 is enclosed by a peripheral wall 414 of the lower connecting portion 41 and a lower wall 416 of the lower connecting portion 41. The lower wall 416 connects with the peripheral wall 414.

The lower connecting portion 41 has two latching blocks 418 formed thereon. The two latching blocks 418 are disposed on an interior surface of the peripheral wall 414 thus, are accommodated in the receiving cavity 412. The latching blocks 418 are advantageously located opposite with each other and protruded from the peripheral wall 414, respectively.

The upper connecting portion 42 is generally rectangular, which is defined with a through latch recess 424. The upper connecting portion 42 is formed on lower wall 416 of the lower connecting portion 41 and located opposite to the receiving cavity 412. The latch recess 424 is defined through the upper connecting portion 42 and configured for facilitating latching of the two latching blocks 418 therein. Due to size of the upper connecting portion 42 being smaller than that of the lower connecting portion 41, a stepped wall 419 is formed between the upper connecting portion 42 and the lower portion.

The plurality of conducting pins 43 is evenly arranged along the stepped wall 419. Each conducting pin 43 is generally a bent rectangular pin and includes a first conducting section 431, a second conducting section 433, and a third conducting section 435. The first conducting section 431, the second conducting section 433, and the third conducting section 435 are generally L-shaped and connected with each other in the order written.

The first conducting section 431 is disposed on the peripheral wall 414 of the lower connecting portion 41 and configured for electrically connecting with the PCB as the board to board connector 40 assembled with the PCB. The second conducting section 433 is formed in the peripheral wall 414 and has a section thereof exposed to the receiving cavity 412. The third conducting section 435 is formed on an exterior wall of the upper connecting portion 42.

Referring further to FIGS. 4 through 6, a stack structure 100 for at least two printed circuit boards is provided. In this embodiment, two board to board connectors, i.e., the first board to board connector 70 and the second board to board connector 80, as illustrated in FIGS. 1 through 3, are exemplified to assemble onto two stacked PCBs, i.e., the first PCB 50 and the second PCB 60. The first PCB 50 and the second PCB 60 respectively have a first mounting hole 501 and a second mounting hole 601 defined therethrough. The first mounting hole 501 and the second mounting hole 601 have substantially the same size and shape. The first mounting hole 501 and the second mounting hole 601 are respectively configured for engaging the corresponding upper connecting portions 72 and 82 of the first board to board connector 70 and the second board to board connector 80 therethrough.

During assembly, the first board to board connector 70 is secured on the first PCB 50. The upper connecting portion 72 thereof engages through the first mounting hole 501 and the step wall 719 resists against the first PCB. As such, the first conducting section 731 of each conducting pin 73 electrically connects with the first PCB 50. The second board to board connector 80 is secured on the second PCB 60 in a similar manner with the securing of the first board to board connector 80 with the first PCB.

After that, the first PCB 50 is stacked on the second PCB 60. The upper connecting portion 72 of the first board to board connector 70 is pressed and received into the receiving cavity 812 of the second board to board connector 80. The two latching blocks (not labeled) of the second board to board connector 80 engage into the two latch recesses (not labeled) of the first board to board connector 70, thus the two latching blocks are latched in the two latch recesses. At this stage, regarding each conducting pin of the first and second board to board connector 70 and 80, the second conducting section 833 of the second board to board connector 80 electrically connects with the third conducting section 735 of the first board to board connector 70. The first PCB 50 and the second PCB 60 are electrically connected, thus the stacking of the first PCB 50 and the second PCB 60 is completed.

One main advantage of the present embodiment embodies that, if a third PCB requires to further stack on the two stacked PCBs 50 and 60, only one additional board to board connector is needed. The additional board to board connector has substantially the same structure as that of the board to board connector 40 as shown in FIGS. 1 through 3. The additional board to board connector is assembled with the first board to board connector 70 or the second board to board connector 80 in such a similar manner with the assembly of the two board to board connectors 70 and 80 onto the two PCBs 50 and 60. Thus, an electric/electronic connection between the third PCB and the two stacked PCBs 50 and 60 is achieved.

Another main advantage of the present embodiment reflects that, due to the latching of the latching blocks and the latch recesses, it is unnecessary to hot-pressure weld the board to board connectors 70 and 80 with the PCBs 50 and 60. Thus, the manufacturing cost is decreased.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A board to board connector, comprising:
a lower connecting portion;
an upper connecting portion disposed on the lower connecting portion; and
a plurality of conducting pins;
wherein the lower connecting portion, the upper connecting portion, and the plurality of conducting pins are integrally manufactured as a whole.

2. The board to board connector as claimed in claim 1, wherein the lower connecting portion has a receiving cavity defined therein, the receiving cavity having substantially the same size and shape as that of the upper connecting portion.

3. The board to board connector as claimed in claim 2, wherein the receiving cavity is enclosed by a peripheral wall of the lower connecting portion and a lower wall of the lower connecting portion, the lower wall connecting with the peripheral wall.

4. The board to board connector as claimed in claim 3, wherein the lower portion has at least one latching block forming on the peripheral wall, the upper connecting portion having at least one recess defined, and the at least one latching block configured for being latching into the at least one recess.

5. The board to board connector as claimed in claim 4, wherein the at least one latching block is accommodated in the receiving cavity, the at least one recess being defined through the upper connecting portion.

6. The board to board connector as claimed in claim 4, wherein the at least one latching block are two latching blocks, the at least one recess being defined through the upper connecting portion, and the two latching blocks being located opposite with each other.

7. The board to board connector as claimed in claim 1, wherein the upper connecting portion and the lower connecting portion have a step wall formed therebetween, the plurality of conducting pins being evenly arranged along the step wall.

8. The board to board connector as claimed in claim 7, wherein the plurality of conducting pins each includes a first conducting pin, a second conducting pin, and a third conducting pin, the first conducting pin, the second conducting pin, and the third conducting pin connecting with each other in the written order.

9. The board to board connector as claimed in claim 8, wherein the first conducting pin, the second conducting pin, and the third conducting pin are generally L-shaped.

10. The board to board connector as claimed in claim 8, wherein the lower connecting portion includes a peripheral wall and a lower wall, the peripheral wall and the lower wall enclosing a receiving cavity, the first conducting pin being disposed on the peripheral wall, the second conducting pin being formed in the peripheral wall and exposed to the receiving cavity, and the third conducting pin being formed on an exterior wall of the upper connecting portion.

11. A stack structure for at least two printed circuit boards, comprising:
at least two board to board connectors corresponding with the at least two printed circuit boards, wherein the at least two printed circuit boards each have a mounting hole defined therethrough, the respective mounting hole is configured for mounting the respective board to board connector therein, the at least two printed circuit boards are electrically connected via physical connections of the at least two board to board connectors.

12. The stack structure as claimed in claim 11, wherein the at least two printed circuit boards are a first printed circuit board and a second printed circuit board, the at least two board to board connectors being a first board to board connector corresponding with the first printed circuit board and a second board to board connector corresponding with the second printed circuit board.

13. The stack structure connector as claimed in claim 12, wherein the mounting hole of the first printed circuit board is a first mounting hole, the mounting hole of the second printed circuit board is a second mounting hole, the first board to board connector and the second board to board connector having one respective upper connecting portion, and the first mounting hole and the second mounting hole being respectively configured for engaging the corresponding upper connecting portion therethrough.

14. The stack structure as claimed in claim 12, wherein the first and second board to board connectors each includes a lower connecting portion, an upper connecting portion disposed on the lower connecting portion, and a plurality of conducting pins, the lower connecting portion, the upper connecting portion, and the plurality of conducting pins being integrally manufactured as a whole.

15. The stack structure as claimed in claim 14, wherein the lower connecting portions of the first and second board to board connectors each has a receiving cavity defined therein, each receiving cavity being configured for receiving the upper connecting portion.

16. The stack structure as claimed in claim 15, wherein the receiving cavity is enclosed by a peripheral wall and a lower wall of the lower connecting portion, the plurality of conducting pins each includes a first conducting pin, a second conducting pin, and a third conducting pin, the first conducting pin, the second conducting pin, and the third conducting pin connecting with each other, the first conducting pin being disposed on the peripheral wall, the second conducting pin being formed in the peripheral wall and exposed to the receiving cavity, and the third conducting pin being formed on an exterior wall of the upper connecting portion.

17. The stack structure as claimed in claim 16, wherein the first conducting pin of each conducting pin electrically connects with the first printed circuit board.

18. The stack structure as claimed in claim 16, wherein the upper connecting portion of the first board to board connector is hold in the receiving cavity of the second board to board connector.

19. The stack structure as claimed in claim 18, wherein the second conducting section of the second board to board connector electrically connects with the third conducting section of the first board to board connector.
